(19) United States
(12) Patent Application Publication
(10) Pub. No.: US 2016/0267096 A1
(43) Pub. Date: Sep. 15, 2016

(54) FILE TRANSMITTING SYSTEM AND METHOD

(71) Applicants: HONG FU JIN PRECISION INDUSTRY (ShenZhen) Co., LTD., Shenzhen (CN); HON HAI PRECISION INDUSTRY CO., LTD., New Taipei (TW)

(72) Inventors: LI-MIN ZHU, Shenzhen (CN); XIAO-YAN ZHANG, Shenzhen (CN); MING-YI CHEN, Shenzhen (CN)

(21) Appl. No.: 14/789,034

(22) Filed: Jul. 1, 2015

(30) Foreign Application Priority Data
Mar. 10, 2015 (CN) 201510103799.1

(51) Int. Cl. G06F 17/30; H04L 29/08

(52) U.S. Cl. CPC G06F 17/30126; H04L 67/06

(57) ABSTRACT

A file transmitting system and method can deliver a file to other directories according to a user's operation. The system and method record status information corresponding to different user interfaces, and are configured to detect a user interface and a file that the user is operating. The system and method further deliver the file to a designated directory from the record without changing a current user interface to the user interface with the designated directory.

### FIELD

The subject matter herein generally relates to a file transmitting system and method.

### BACKGROUND

Data storage vendors provide more useful functions to users, such as backing up data from local to a server. For example, the user can choose a file in one user interface of a local device (e.g. mobile phone), and drag the file to the other user interface that presents the file directory regarding to the server.

### BRIEF DESCRIPTION OF THE DRAWINGS

Implementations of the present technology will now be described, by way of example only, with reference to the attached figures.

FIG. 1 is a block diagram of an embodiment of a file transmitting system of the present disclosure, wherein the file transmitting system comprises a computer and terminal device.

FIG. 2 is a block diagram of the computer of FIG. 1, wherein the computer comprises a Memory device with an identity table stored therein.

FIG. 3 is a block diagram of the terminal device of FIG. 1.

FIG. 4 is a block diagram of the computer and the terminal device of FIG. 1.

FIG. 5 is a block diagram of a identity table of the present disclosure.

FIG. 6 is an example of a first interface with a first directory of a user interface of the file transmitting system of the present disclosure.

FIG. 7 is an example of a second interface with a second directory of the user interface of the file transmitting system of the present disclosure.

FIG. 8 is an example of the second interface with a first file delivery of the user interface of the file transmitting system of the present disclosure.

FIG. 9 is an example of the first interface with the first file selected of the user interface of the file transmitting system of the present disclosure.

FIG. 10 is an example of a third interface with a third directory of the user interface of the file transmitting system of the present disclosure.

FIG. 11 is an example of the second interface with a second file delivery of the user interface of the file transmitting system of the present disclosure.

FIG. 12 is an example of the third interface with the second file delivery of the user interface of the file transmitting system of the present disclosure.

FIG. 13 is an example of the first interface with the second file delivery of the user interface of the file transmitting system of the present disclosure.

FIG. 14 is a flow chart of a file transmitting method of the present disclosure.

FIG. 15 is a flow chart of responding to the user's input of FIG. 14.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The present disclosure is described in relation to file delivery between different file directories through a user interface.

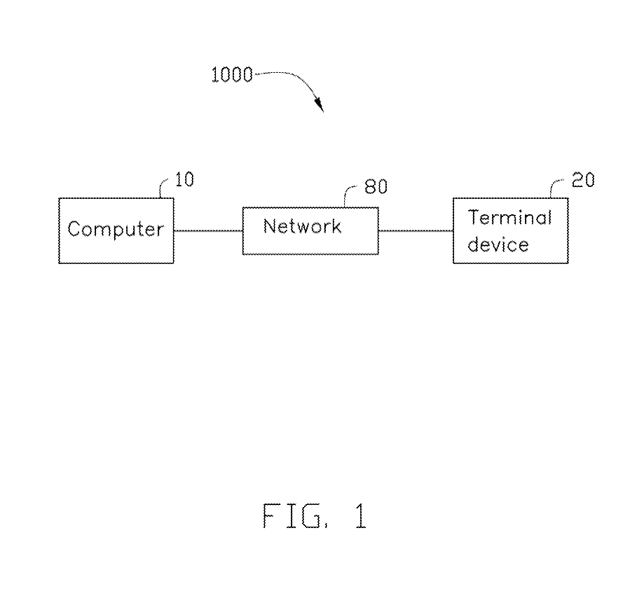

FIG. 1 illustrates a file transmitting system 1000 of the present disclosure. The file transmitting system 1000 can comprise a computer 10 and a terminal device 20 configured to communicate with the computer 10 through a network 80. In at least one embodiment, the terminal device 20 (e.g. a first device) can communicate with the computer 10 (e.g. a second device) through a wired and/or wireless network. The terminal device 20 can be a cell phone with a plurality of programs running therein. In other embodiments, the terminal device 20 can also communicate with other portable devices, such as a person assistant device (PAD), through the wireless network.

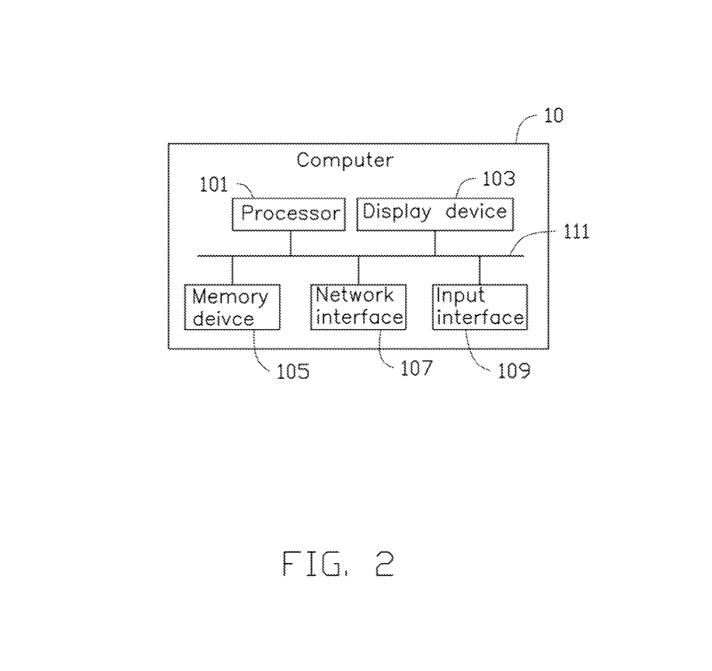

FIG. 2 illustrates that the computer 10 can comprise a display device 103, a memory device 105, a network interface 107, an input interface 109, and a processor 101 electrically coupled to the display 103, the memory device 105, the network interface 107, and the input interface 109 through a first bus 111.

In at least one embodiment, the input device 109 can be electrically coupled to a keyboard and/or a mouse, to generate the user's input. The network interface 107 can be electrically coupled to a network card. The memory device 105 can store a plurality of programs to be executed by the processor 101 to perform certain functions, such as making a share directory, creating a wireless access point, displaying a plurality of user interfaces, and detecting user's input. In other embodiments, the computer 10 can also access to a mobile network, such as the 4G (4th generation) mobile network, through the network interface 107.

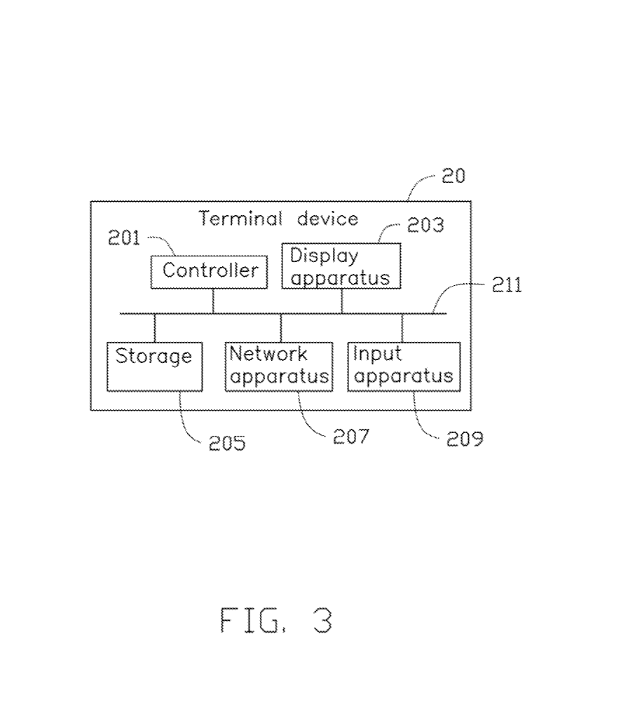

FIG. 3 illustrates the terminal device 20 that can comprise a display apparatus 203, a storage 205, a network apparatus 207, an input apparatus 209, and a controller 201 electrically coupled to the display apparatus 203, the storage 205, the network apparatus 207, and the input apparatus 209 through a second bus 211. In at least one embodiment, the network apparatus 207 can be electrically coupled to a wireless network card. The display apparatus 203 can be used to display a plurality of user interfaces. The input apparatus 209 can be electrically coupled to a sensing device, so as to perform corresponding operations on the user interface according to user's input. The storage 205 can store a plurality of programs to be executed by the controller 201 to perform certain functions, such as accessing the wireless access point created by the computer 10, performing uploading a file, downloading a file, moving a file, and/or copying a file operations according to the user's inputs.

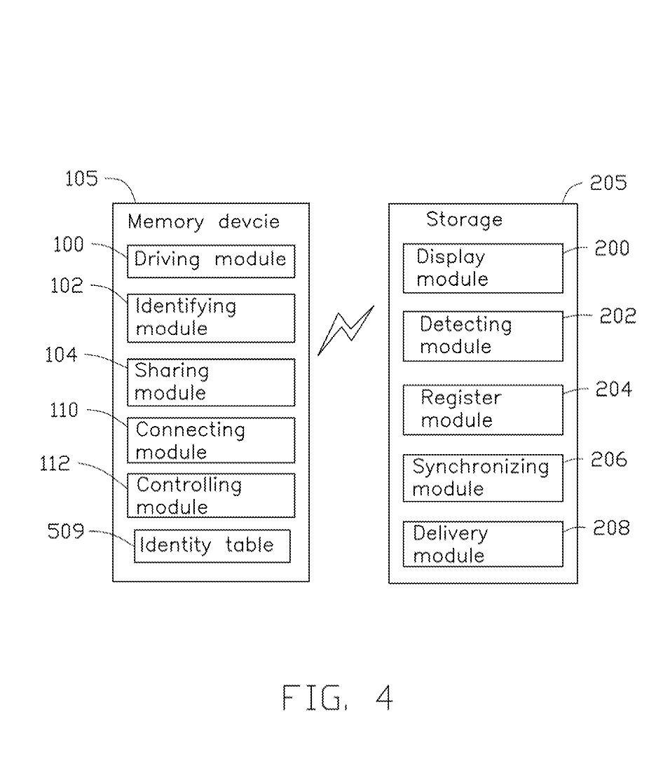

FIG. 4 illustrates that the storage 205 of the terminal device 20 can comprise a display module 200, a detecting module 202, a register module 204, a synchronizing module 206, and a delivery module 208.

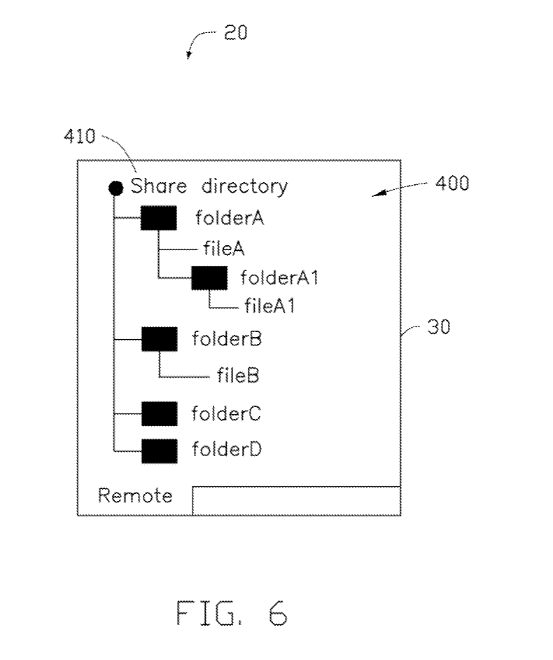

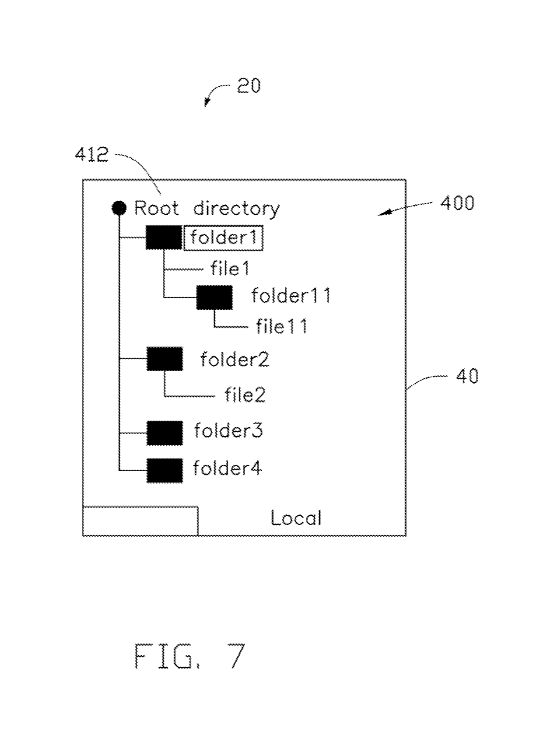

In at least one embodiment, the display module 200 can display a first interface 30 (shown in FIG. 6), and a second interface 40 (shown in FIG. 7) in the display apparatus 203 of the terminal device 20. The detecting module 202 can detect user's input, such as opening an application, selecting a file, clicking the first interface 30 or the second interface 40, according to the input apparatus 209. In at least one embodiment, the first interface 30 can be hidden when the second interface 40 is selected, and the second interface 40 can be hidden when the first interface 30 is selected. The first interface 30 is configured to present information corresponding to a first directory 400 (e.g. listing folders and files beyond a “Share directory” in FIG. 6) including a first status information 410 (e.g. the “Share directory” in FIG. 6), the second interface 40 is configured to present information corresponding to a second directory 401 (e.g. listing folders and files beyond a “Root directory” in FIG. 7) including a second status information 412 (e.g. the “Root directory” in FIG. 7). In at least one embodiment, the first directory 400 presents information corresponding to the share directory of the computer 10, the second directory 401 presents information corresponding to a local directory (e.g. “Root directory”) of the terminal device 20.

The synchronizing module 206 can obtain the first status information 410 in the first interface 30 of the terminal device 20, and also obtain the second status information 412 in the second interface 40 of the terminal device 20. In other embodiments, the first interface 50 can present information corresponding to another local directory (e.g. “Root directory\folder1”) of the terminal device 20.

The register module 204 can present first delivery information 420 in the first interface 30, or present second delivery information 406 in the second interface 40.

The delivery module 208 can perform an upload, move, copy, and/or download operation on a selected file.

The memory device 105 of the computer 10 can comprise a driving module 100, a identifying module 102, a sharing module 104, a connecting module 110, an identify table 509, and a controlling module 112. In at least one embodiment, the memory device 105 can be a volatile memory unit or units. In other embodiments, the memory device 105 can be a non-volatile memory unit or units. The memory device 105 may also be another form of computer-readable medium, such as a magnetic or optical disk.

The controlling module 112 can perform a move, copy, and/or download operation on a selected file.

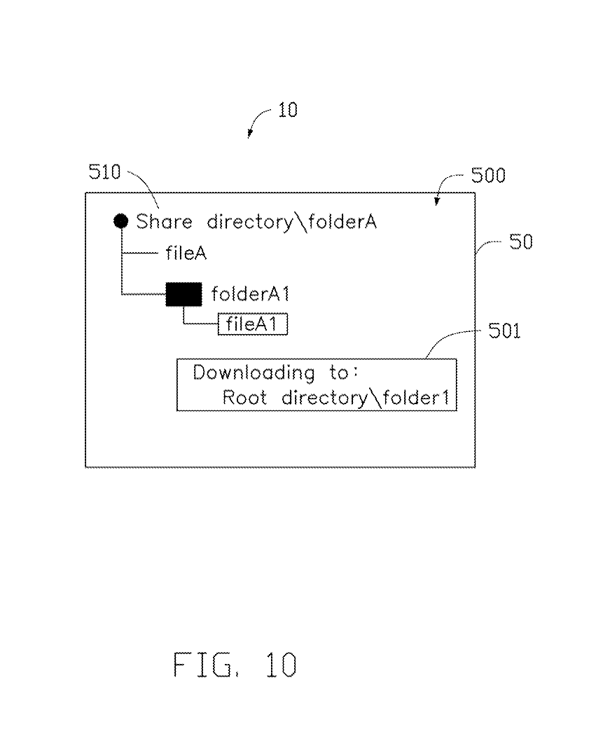

The driving module 100 can present a third interface 50 (shown in FIG. 10) on the display device 103 of the computer 10. In at least one embodiment, the third interface 50 is configured to present information corresponding to a third directory 500 (e.g. listing folders and files beyond “Share directory\folderA” in FIG. 10) including third status information 510 (e.g. the “Share directory\folderA” in FIG. 10).

The sharing module 104 can create the share directory. In at least one embodiment, the share directory can be created in the computer 10. In other embodiments, the share directory can be created in another server.

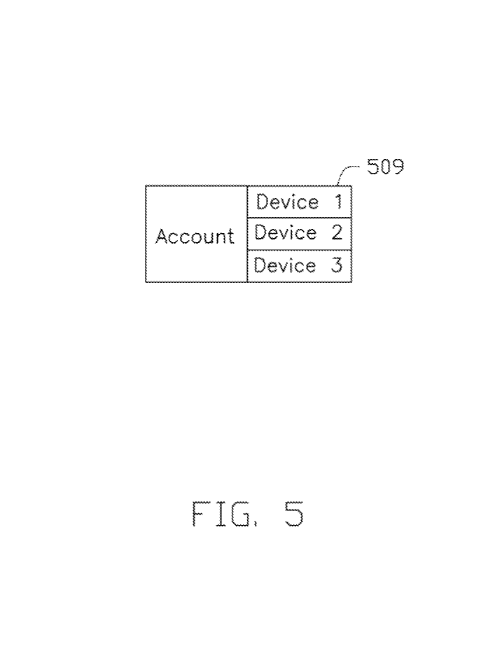

FIG. 5 illustrates that the identify table 509 can comprise accounts and device identifies (such as “Device 1”, “Device 2”, and “Device 3”). The identifying module 102 can determine whether the terminal device 20 has been authorized to access the share directory according to the identify table 509. In at least one embodiment, when the account with which the terminal device 20 accesses the share directory exists in the identify table 509, the terminal device 20 is permitted to access the share directory. In other embodiments, when the account and the device identify of the terminal device 20 exit in the identify table 509, the terminal device 20 has the authorization to access the share directory.

The control module 112 can obtain the third status information 510 in the third interface 50, and also obtain the first and second status information 410 and 412 through the network 80 when the terminal device 20 accesses to the share directory. In at least one embodiment, the control module 112 can synchronize the status information according to the device identification. The synchronizing module 206 of the terminal device 20 can perform a synchronization operation, to obtain the third status information 510 from the computer 10. The control module 113 can detect the user's input on the computer 10 and perform corresponding operations, such as creating the wireless access point. In other embodiments, the wireless access point may not be created when the terminal device 20 communicates with the computer 10 through a wire network.

FIGS. 6 and 7 illustrate that the first interface 30 can present the first directory 400 with the first status information 410, the second interface 40 can present the second directory 401 with the second status information 412.

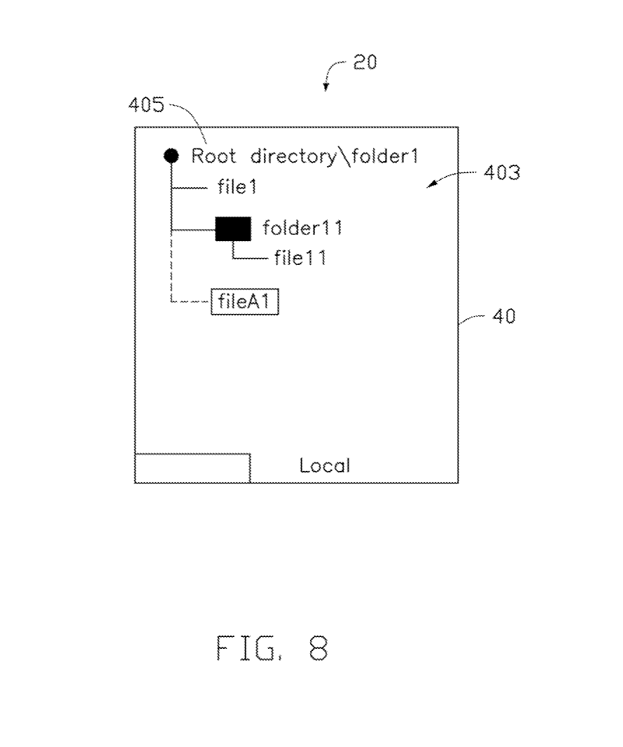

FIG. 8 illustrates that the second interface 40 can present a third directory 403 when the “folder1” of the second directory 401 is selected, and fourth status information 405 of the second interface 40 is changed to “Root directory\folder1”.

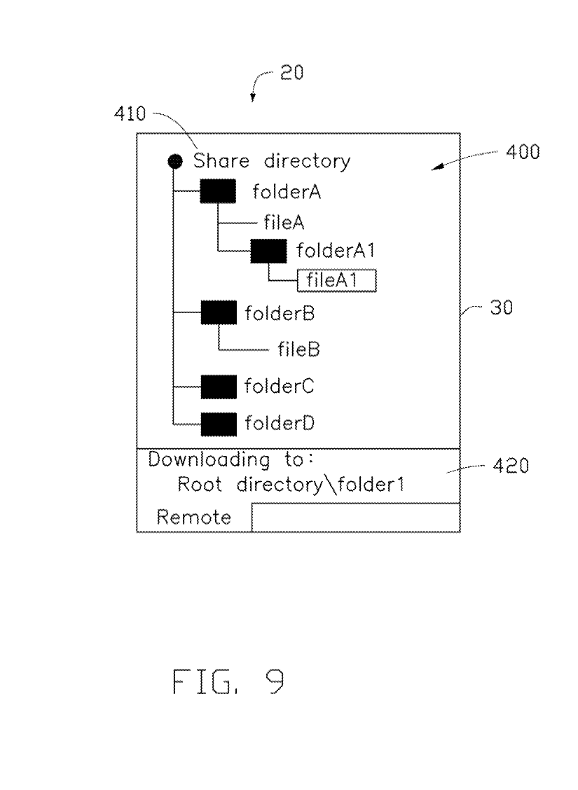

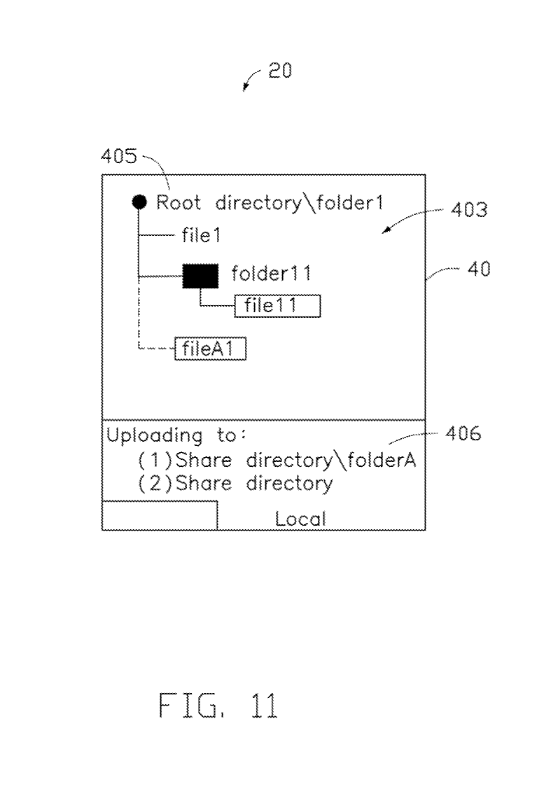

FIG. 9 illustrates that a first file (e.g. “fileA1”) of a first embodiment can be delivered to the terminal device 20 from the computer 10. When the first file under the first directory 400 is selected, the synchronizing module 206 can obtain status information of the second interface 40 which is the fourth status information 405 “Root directory\folder1”. The registering module 204 can present first delivery information 420 in the first interface 30. When the first delivery information 420 is confirmed, such as clicked by the user, the delivery module 208 then downloads the first file (e.g. “fileA1”) to the “folder1” (shown in FIG. 11), so as to deliver the first file to the terminal device 20. In other embodiments, the registering module 204 can present the first delivery information 420 according to an operation history on the local directory in the terminal device 20. For example, the operation history on the local directory in the terminal device 20 can comprise the second status information 412 and the fourth status information 405, thus, the first delivery information 420 presented in the first interface 30 can comprise the second status information 412 and the fourth status information 405, and providing an option for the user to download the first file (e.g. “fileA1”) to the “Root directory” and/or “Root directory\folder1”.

FIG. 10 illustrates that the first file of a second embodiment can be delivered to the terminal device 20. When the first file within the third interface 50 is selected, the control module 112 of the computer 10 can obtain the first status information 405 in the second interface 40 through the synchronizing module 206 of the terminal device 20 and present third delivery information 501 in the third interface 50. The first file can be delivered to the terminal device 20 by the connecting module 110, when the third delivery information 501 is confirmed. In other embodiments, the third delivery information 501 can be presented according to the operation history on the local directory in the terminal device 20. For example, the operation history on the local directory in the terminal device 20 can comprise the second status information 412 and the fourth status information 405, the third delivery information 501 can comprise the second status information 412 and the fourth status information 405, and providing an option for the user to download the first file (e.g. “fileA1”) to the “Root directory” and/or “Root directory\folder1”.

FIG. 11 illustrates a second file to be delivered in the terminal device 20. When the second file (e.g. “file11”) in the second interface 40 is selected, the synchronizing module 206 can obtain the first status information 410 in the first interface 30 (e.g. the “Share directory” shown in FIG. 6), and also obtain the third status information 510 (e.g. the “Share directory\folderA” shown in FIG. 10) in the third interface 50 through the controlling module 112 of the computer 10. The registering module 204 can present the second delivery information 406, the second delivery information 406 can comprise the first status information 410 and the third status information 510, and provide an option from the user to upload the second file (e.g. “file11”) to the “Share directory” and/or “Share directory\folderA”.

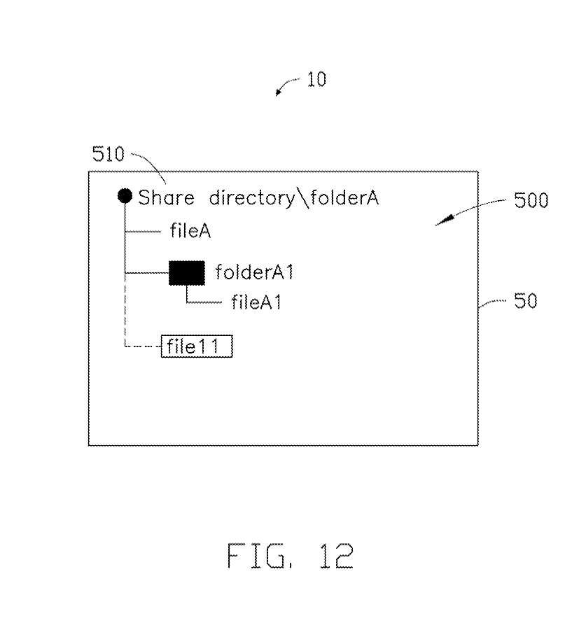

FIG. 12 illustrates that the second file has been delivered in the third interface 50. When the “Share directory\folderA” in the second interface 40 is confirmed, the second file is delivered to the “Share directory\folderA” of the computer 10.

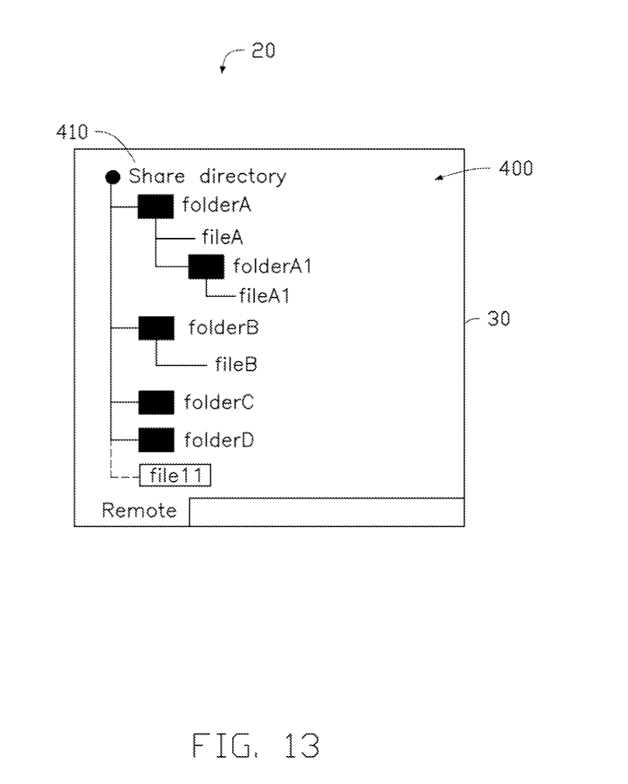

FIG. 13 illustrates that the second file has been delivered in the first interface 30. When the “Share directory” in the second interface 40 is confirmed, the second file is delivered to the “Share directory” of the computer 10.

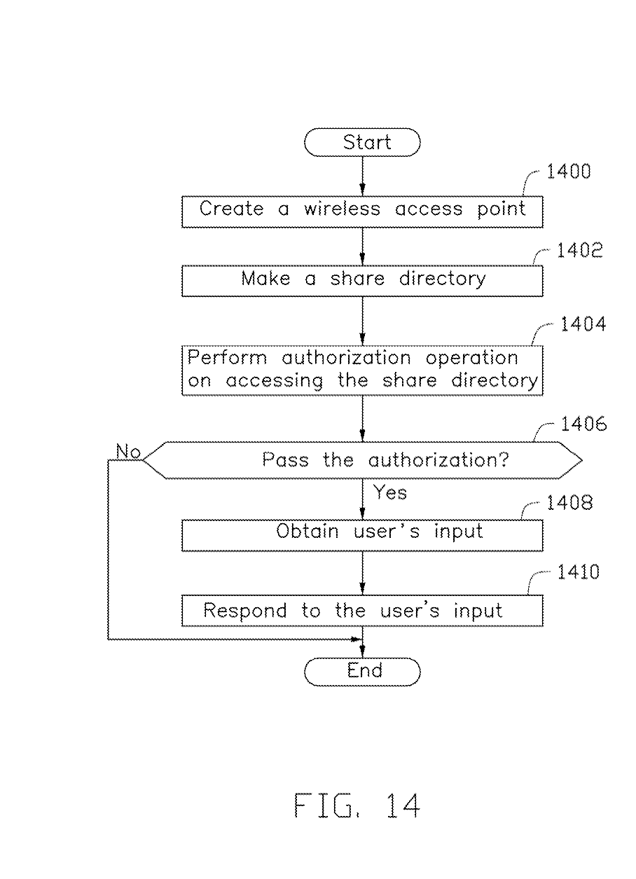

FIG. 14 illustrates a file transmitting method of the present disclosure. The example method is provided by way of example, as there are a variety of ways to carry out the method. The method described below can be carried out using the configurations illustrated in FIGS. 1-13, for example, and various elements of these figures are referenced in explaining example method. Each block shown in FIG. 14 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 1400.

At block 1400, the computer can create a wireless access point.

At block 1402, the computer can make a share directory.

At block 1404, the computer can perform authorization operation on accessing the share directory of a user through a terminal device.

At block 1406, the computer can determine whether the user has the authorization on accessing the share directory, when the user passes the authorization, block 1408 is implemented; when the user fails, the process ends.

At block 1408, the computer or the terminal device can obtain the user's input.

At block 1410, the computer or the terminal device can respond to the user's input.

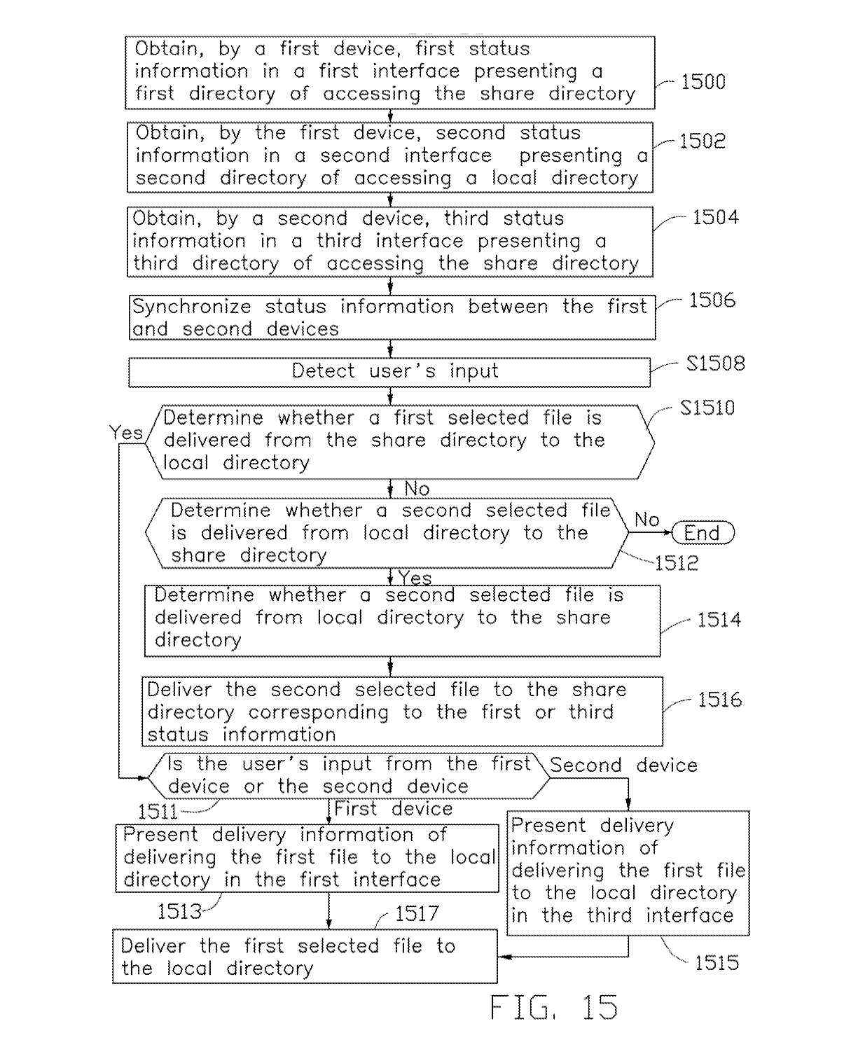

FIG. 15 illustrates that the block 1410 can further comprise blocks as follow.

At block 1500, the terminal device can obtain first status information in a first interface presenting a first directory of accessing the share directory.

At block 1502, the terminal device can obtain second status information in a second interface presenting a second directory of accessing a local directory of the terminal device.

At block 1504, the computer can obtain third status information in a third interface presenting a third directory of accessing the share directory.

At block 1506, the computer and the terminal device can synchronize status information between each other.

At block 1508, the computer or the terminal device can detect corresponding user's input.

At block 1510, the system can determine whether a first selected file is delivered from the share directory to the local directory according to the user's input. When the first selected file is delivered from the share directory to the local directory, block 1511 is implemented. When the first selected file is not configure to deliver from the share directory to the local directory, block 1512 is implemented.

At block 1512, the terminal device can determine whether a second selected file is configured to deliver from local directory to the share directory of the computer according to the user's input. When the second selected file is configured to deliver from the local directory to the share directory, block 1514 is implemented. Otherwise, the process ends.

At block 1514, the terminal device can present the second deliver information according to the first and third status information. In at least one embodiment, the second delivery information is presented in the second interface.

At block 1516, the terminal device transmits the second selected file to the share directory of the computer corresponding to the first and/or third status information.

At block 1511, a determination is made that the user's input is from the computer or the terminal device. When the user's input is from the computer, block 1515 is implemented. When the user's input is from the terminal device, block 1513 is implemented.

At block 1513, the terminal device can present the first delivery information in the first interface according to the first status information, block 1517 is implemented.

At block 1515, the computer can present the third delivery information in the third interface, and block 1517 is implemented.

At block 1517, the first selected file is delivered to the terminal device according to the first status information.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A system comprising:
a controller; and
a storage coupled to the controller and comprising a plurality of programs which, when executed by the controller, comprises:
a display module configured to display a first user interface and a second user interface, wherein the first user interface comprises first status information corresponding to a first directory, the second user interface comprise second status information corresponding to a second directory;
a synchronizing module configured to obtain the first status information and the second status information;
a register module configured to present, in response to a first operation being performed on a first file in the first user interface, first delivery information corresponding to the second status information; and
a delivery module configured to deliver, in response to the first delivery information being confirmed, the first file to the second directory.

2. The system of claim 1, wherein the register module present, in response to a second operation being performed on a second file, second delivery information corresponding to the first status information in the second user interface; the delivery module delivers, in response to the second delivery information being confirmed, the second file to the first directory.

3. The system of claim 2, wherein the first user interface and second user interface are presented in a computing device, the first user interface comprise the first status information corresponding to a share directory, the second user interface comprise the second status information corresponding to a local directory of the computing device; when the first user interface is presented, the second user interface is hidden, when the second user interface is presented, the first user interface is hidden.

4. The system of claim 2, wherein the first user interface is presented in a first computing device, the second user interface is presented in a second computing device; the first user interface comprises the first status information corresponding to a share directory creating in the first computing device, the second user interface comprises the second status information corresponding to a local directory in the second computing device.

5. A system comprising:
a first device, comprising:
a controller;
a storage coupled to the controller, and comprising a plurality of programs which, when executed by the controller, comprises:
a display module configured to display a first user interface and a second user interface, wherein the first user interface comprises first status information corresponding to a share directory, the second user interface comprise second status information corresponding to a local directory; and
a second device, comprising:
a processor; and
a memory device coupled to the processor, and comprising a plurality of programs which, when executed by the processor, comprises:
a driving module configured to display a third user interface, wherein the third user interface comprises third status information corresponding to the share directory;
a controlling module configured to obtain the second status information, wherein the controlling module is further configured to present, in response to a first operation being performed on a first file in the third user interface, first delivery information in the third user interface corresponding to the second status information; and
a connecting module configured to deliver, in response to the first delivery information being confirmed, the first file to the second directory.

6. The system of claim 5, wherein the controlling module presents the first delivery information according to a first operation history of accessing the local directory through the second user interface.

7. The system of claim 5, wherein the storage of the first device further comprises:
a synchronizing module configured to obtain the first status information and the third status information;
a register module configured to present second delivery information corresponding to the first and third status information in response to a second operation being performed on a second file in the second user interface; and
a delivery module configured to deliver the second file to the first and/or third directory in response to the second delivery information being confirmed.

8. The system of claim 7, wherein the register module presents the second delivery information according to a second operation history of accessing the share directory through the first and/or third user interface.

9. The system of claim 7, wherein the register module is configured to present, in response to a third operation being performed on a third file in the first user interface, third delivery information corresponding to the second status information, the delivery module delivers, in response to the third delivery information being confirmed, the third file to the second directory.

10. The system of claim 9, wherein the register module presents the third delivery information according to a third operation history of accessing the local directory through the second user interface.

11. The system of claim 8, wherein when the first user interface is presented, the second user interface is hidden, when the second user interface is presented, the first user interface is hidden.

12. A method, comprising:
displaying a first user interface and a second user interface in a first device, wherein the first user interface comprises first status information corresponding to a share directory, the second user interface comprise second status information corresponding to a local directory;
displaying a third user interface in a second device, wherein the third user interface comprises third status information corresponding to the share directory;
obtaining the second status information;
presenting, in response to a first operation being performed on a first file in the third user interface, first delivery information in the third user interface corresponding to the second status information; and
delivering, in response to the first delivery information being confirmed, the first file to the second directory.

13. The method of claim 12, further comprising:
presenting the first delivery information according to a first operation history of accessing the local directory through the second user interface.

14. The method of claim 12, further comprising:
obtaining the first status information and the third status information;
presenting second delivery information corresponding to the first and third status information in response to a second operation being performed on a second file in the second user interface; and
delivering, in response to the second delivery information being confirmed, the second file to the first and/or third directory.

15. The method of claim 14, further comprising:
presenting the second delivery information according to a second operation history of accessing the share directory through the first and/or third user interface.

16. The method of claim 14, further comprising:
presenting, in response to a third operation being performed on a third file in the first user interface, third delivery information corresponding to the second status information; and
delivering, in response to the third delivery information being confirmed, the third file to the second directory.

17. The method of claim 16, further comprising:
presenting the third delivery information according to a third operation history of accessing the local directory through the second user interface.

18. The method of claim 16, further comprising:
when the first user interface is presented, the second user interface is hidden;
when the second user interface is presented, the first user interface is hidden.
